(19) United States
(12) Patent Application Publication
(10) Pub. No.: US 2011/0234725 A1
(43) Pub. Date: Sep. 29, 2011

(54) INK-JET RECORDING METHOD AND INK SET

(75) Inventor: Naotaka WACHI, Ashigarakami-gun (JP)

(73) Assignee: FUJIFILM CORPORATION, Tokyo (JP)

(21) Appl. No.: 13/069,570

(22) Filed: Mar. 23, 2011

(30) Foreign Application Priority Data
Mar. 24, 2010 (JP) 2010-067975

(51) Int. Cl. B41J 2/01; C09D 11/02

(52) U.S. Cl. 347/102; 106/31.13

(57) ABSTRACT

An ink-jet recording method, having the steps of: ejecting droplets of inks from an orifice of a recording head onto a recording sheet in response to recording signals; and heating the recording sheet to 70° C. or higher before the droplets of the ink land on the recording sheet or at the time of landing thereof, thereby to form a multi-order color image on the recording sheet, in which the inks are two or more kinds of inks that thicken by heating and have different color hues from each other, and the droplets of the inks are ejected in sequence from the ink having the lowest viscosity at 70° C. among the inks.

### FIELD OF THE INVENTION

The present invention relates to an ink-jet recording method and an ink set using the same.

### BACKGROUND OF THE INVENTION

The ink-jet recording has such a lot of advantages that a high-speed recording is possible; a low noise level is achieved; colorization is easy; a high resolution can be made; and a plain paper recording is possible. Because of these advantages, instruments and equipments using such recording method are remarkably in widespread use. As the ink used in this recording method, an aqueous ink is dominant from the viewpoints of safety, odor and the like. In the ink-jet recording method, image formation is performed by ejecting (discharging) the ink in a rate of several thousands or more drops per second.

In the case where a high-speed printing is performed by the ink-jet recording method, aggregation and color bleeding may occur. Specifically, the term “aggregation” signifies a phenomenon in which before absorption of the first ink droplet into a paper has been completed, the second ink droplet reaches to the first ink droplet and they are united or aggregated to form one large liquid droplet. The image resolution is deteriorated by the aggregation. On the other hand, the term “color bleeding” signifies a phenomenon in which image sharpness and color quality are deteriorated on the grounds that two droplets, which are to be united, contain a colorant having a different color from each other.

As a method contemplated to address the problem of color bleeding in a high-speed printing, a method of using an ink that turns into a gel in response to heat, and printing the ink on a recording element (paper) having been heated at a higher temperature than that of the ink is proposed (see JP-A-2003-285532 (“JP-A” means unexamined published Japanese patent application)). Further, in order to resolve bleeding and color bleeding as well as to form a highly coloring image, an ink-jet aqueous ink containing a thermoreversible thickening polymer is proposed (see JP-A-9-39381).

In the ink set used for a color print, inks based on four color hues of yellow (Y), magenta (M), cyan (C) and black (B) are ordinarily used in combination. In the time of image formation, inks are sequentially ejected in each color and thereby printing is performed. In the case where techniques disclosed in JP-A-2003-285532 and JP-A-9-39381 are used in the ink-jet recording that forms the above-described multi-order color images, a high-temperature gelling ability of the ink in each color hue depends on each of the ink composition. The present inventors confirmed that in the multi-order color image formation, bleeding of the dots at an overlap portion of the first-order color and the second-order color may not be sufficiently prevented due to a difference in the high-temperature gelling ability between the inks having different color hue.

### SUMMARY OF THE INVENTION

The present invention resides in an ink jet recording method, comprising the steps of:

ejecting droplets of inks from an orifice of a recording head onto a recording sheet in response to recording signals; and

heating the recording sheet to 70° C. or higher before the droplets of the ink land on the recording sheet or at the time of landing thereof, thereby to form a multi-order color image on the recording sheet,

wherein the inks are two or more kinds of inks that thicken by heating and have different color hues from each other, and

wherein the droplets of the inks are ejected in sequence from the ink having the lowest viscosity at 70° C. among the inks.

Further, the present invention resides in an ink set, comprising inks which thicken by heating,

wherein the inks comprise color hues of black, cyan, magenta, and yellow, and

wherein the inks satisfy the following relation in terms of viscosity at 70° C. thereof:

the black ink<the cyan ink<the magenta ink<the yellow ink.

Other and further features and advantages of the invention will appear more fully from the following description.

### DETAILED DESCRIPTION OF THE INVENTION

According to the present invention, there are provided the following means:

(1) An ink-jet recording method, comprising the steps of:

ejecting droplets of inks from an orifice of a recording head onto a recording sheet in response to recording signals; and

heating the recording sheet to 70° C. or higher before the droplets of the ink land on the recording sheet or at the time of landing thereof, thereby to form a multi-order color image on the recording sheet,

wherein the inks are two or more kinds of inks that thicken by heating and have different color hues from each other, and

wherein the droplets of the inks are ejected in sequence from the ink having the lowest viscosity at 70° C. among the inks.

(2) The ink-jet recording method described in the above item (1), wherein the ink comprises a pigment, water, and a heat-sensitive material.
(3) The ink-jet recording method described in the above item (2), wherein the above-described heat-sensitive material is a block polymer containing an ethylene oxide moiety and a propylene oxide moiety.
(4) The ink-jet recording method described in any one of the above items (1) to (3), wherein each of the two or more kinds of inks has a viscosity of 10 mPa·s or less at 25° C. and 100 mPa·s or more at 70° C.
(5) The ink jet recording method described in any one of the above items (1) to (4), wherein the recording sheet is printed in a single pass mode.
(6) The ink-jet recording method described in any one of the above items (1) to (5), wherein the two or more kinds of inks having different color hues comprise a yellow ink, a magenta ink, a cyan ink, and a black ink.
(7) The ink-jet recording method described in the above item (6), wherein the inks satisfy the following relation in terms of viscosity at 70° C. thereof:

the black ink<the cyan ink<the magenta ink<the yellow ink.

(8) An ink set, comprising inks which thicken by heating,

wherein the inks comprise color hues of black, cyan, magenta, and yellow, and

wherein the inks satisfy the following relation in terms of viscosity at 70° C. thereof:

the black ink<the cyan ink<the magenta ink<the yellow ink.

(9) The ink set described in the above item (8), wherein each of the inks has a viscosity of 10 mPa·s or less at 25° C. and 100 mPa·s or more at 70° C.

First, the ink-jet recording method of the present invention will be described.

### [Ink-Jet Recording Method]

The ink jet recording method is a method to form images by ejecting ink droplets from a plurality of nozzles or orifices built in a recording head of an ink-jet printer, and allowing the ink droplets to land on a recording sheet while controlling the ink droplets by the ejection. This method is roughly classified into a method of ejecting liquid droplets by applying a mechanical energy to the liquid droplets and a method of ejecting liquid droplets by bubble release resulting from application of heat energy to the liquid droplets. In the present invention, any one of these methods may be used. A piezo-type recording head is preferably used. If a thermal type head is used, an ink may thicken due to heat at the time of ejecting the ink. As a result, the ejection direction or ejection amount of the ink may become unstable. In some cases, ejection may become impossible. In contrast, use of the piezo head makes it possible to eject the ink very well, so the piezo head is preferable.

As the method of recording a color image, there are a shuttle scan mode and a single pass mode. In the shuttle scan mode (shuttle scan system), recording is performed by scanning a head relative to the same recording portion more than once. On the other hand, in the single pass mode (single pass system), recording is performed by scanning only once a head relative to a recording portion. Of these modes, the recording method of the present invention is favorably suitable for the single pass mode. The recording method of the present invention has the following characteristics due to use of a high-temperature gelling ink described later. After landing of the ink onto a recording sheet, hard dots are formed in a short time. As a result, in the single pass mode in which the second-order color lands directly after landing of the first-order color, both color bleeding and dot bleeding are prevented. Accordingly, effects such as enhancement of image quality are achieved.

The printing speed is not particularly limited. However, since the present invention makes it possible to obtain excellent images even in a high-speed printing, the range of from 50 m/min to 200 m/min is preferred. Though the liquid amount per droplet is not particularly limited, the range of from 2 to 15 pl is preferred.

In the ink-jet recording method of the present invention, image formation is performed by ejecting ink droplets from a recording head. In addition, the ink jet recording method of the present invention is characterized in that the recording sheet is heated to 70° C. or higher before the ink droplets land, or at the time of landing, preferably in the range of from 70° C. to 100° C., more preferably in the range of from 70° C. to 90° C., and still more preferably in the range of from 70° C. to 80° C. This temperature is defined as a value obtained by measuring a temperature at the side of the ink jet recording (the side at which ink droplets land) of the recording sheet using a noncontact thermometer such as an infrared thermometer (for example, IR-66B (trade name), manufactured by MK Scientific, Inc.). The measuring position is set between a head section of the ink jet recording apparatus and a means (unit) that heats a recording sheet. If the heating temperature is too low, the ink may not sufficiently thicken. Further, in order to heat to a higher temperature than the above-described temperature, extra heat sources are needed. As a result, the extra heat sources become a load on the system. In addition, heating may be carried out both before the ink droplets land and at the time of landing. In the method of the present invention, the thickening of the ink on a recording sheet is accelerated by heating on the recording sheet whereby, for example, bleeding can be suppressed.

The ink jet recording method of the present invention is further characterized in that the lower the viscosity of the ink at 70° C. is, among the inks having color hues that are different from each other, the earlier the ejecting order is. By adjusting a high-temperature gelling ability of the ink according to the ejecting order, dot bleeding at the overlap portion between dots having different colors from each other can be prevented. This phenomenon appears to be caused by the following reasons.

In the case where dots are formed with the second ink (second-order ink) on an image having been formed with the first ink (first-order ink), penetration of water into the ink is delayed, as compared with the case where dots are directly formed at a non-image area. Accordingly, the overlap portion between dots having different colors from each other is inferior in efficiency of increasing viscosity that accompanies a temperature rise of the ink due to heating, and resultantly bleeding of the ink tends to become worse. In the case where the first ink is more likely to thicken at a high temperature than the second ink, the second ink on the formed image becomes more difficult to penetrate. As a result, this tendency becomes more conspicuous. Accordingly, when the high-temperature gelling ability of the ink that forms an image in first is lower than that of the ink that forms an image on the previously-formed image, dot bleeding at the overlap portion between these images is hardly caused.

In the case where inks each having the same viscosity at 70° C. are contained, ejecting may be carried out regardless of the inks. Given the quality of the obtained image, however, it is preferred to use the ink of lower saturation first and the ink of higher saturation later.

In the ink-jet recording method of the present invention, the inks having different color hues from each other preferably contain inks of at least yellow, magenta, cyan and black. Further, it is especially preferred to use an ink set composed of inks that satisfy the following relation of viscosity at 70° C.: black ink<cyan ink<magenta ink<yellow ink, and in addition to print in the order of the black ink, the cyan ink, the magenta ink and the yellow ink. The above-described ejecting order is favorable since a sharp print quality is obtained without causing bleeding at the overlap portion between the different colors.

In the ink jet recording method of the present invention, two or more kinds of inks having different color hues from each other are used. For example, an embodiment where an ink of other color hue may be also used together with the above-described four kinds of inks having different color hues from each other is practiced without any particular limitation. In order to achieve broader color reproduction range, for example, the ink set may contain a part or all of special colors such as red, green and blue. With respect to the ejecting order in this case, it is preferred to eject in such an order that the ink having the lowest viscosity at 70° C. is first as described above. It is more preferred that the viscosity at 70° C. of each of the inks to be used is adjusted so as to become higher in the order as the saturation thereof becomes higher.

The recording sheet to be used may be, but not limited to, a sheet of general printing paper (plain paper) containing cellulose as a main component, such as so-called high-quality paper, coated paper, or art paper. When general printing paper containing cellulose as a main component is used in image recording by a conventional ink-jet method with a water-based ink, the ink may be absorbed in the paper and dried relatively slowly, so that colorants in the ink may be likely to migrate after being provided on the paper, which may easily lead to image quality deterioration. According to the ink-jet recording method of the invention, however, the migration of the colorants (pigments) may be suppressed so that high-quality image recording with good color density and suppression of penetration of the ink may be achieved.

Generally commercially available recording sheet may be used as the recording sheet, and examples thereof include high-quality paper (A) such as OK PRINCE HIGH-QUALITY (trade name, manufactured by Oji Paper Co., Ltd.), SHIORAI (trade name, manufactured by Nippon Paper Industries Co., Ltd.) and NEW NPI HIGH-QUALITY (trade name, manufactured by Nippon Paper Industries Co., Ltd.); lightly coated paper such as OK EVER LIGHT COAT (trade name, manufactured by Oji Paper Co., Ltd.) and AURORA S (trade name, manufactured by Nippon Paper Industries Co., Ltd.); lightweight coated paper (A3) such as OK COAT L (trade name, manufactured by Oji

Paper Co., Ltd.) and AURORA L (trade name, manufactured by Nippon Paper Industries Co., Ltd.); coated paper (A2, B2) such as OK TOP COAT+(trade name, manufactured by Oji Paper Co., Ltd.) and AURORA Coat (trade name, manufactured by Nippon Paper Industries Co., Ltd.); and art paper (A1) such as OK KANAFUJI+(trade name, manufactured by Oji Paper Co., Ltd.) and TOKUBISHI ART (trade name, manufactured by Mitsubishi Papers Mills Ltd.).

### [High-Temperature Gelling Ink]

In the ink-jet recording method of the present invention, at least two kinds of inks that thicken in response to heating are used. The phrase “thickens in response to heating” signifies that the difference in ink viscosity between at 25° C. and at 70° C. is 70 mPa·s or more.

Hereinafter, the ink which is used in the present invention, whose viscosity thickens in response to heating is referred to as “a high-temperature gelling ink”.

The high-temperature gelling ink of the present invention contains a heat-sensitive material to be hereinafter described. The viscosity at 70° C. is preferably 100 mPa·s or more, and more preferably 150 mPa·s or more. The upper limit of the viscosity at 70° C. is not particularly restricted. A relatively higher viscosity is preferred. However, the viscosity is ordinarily 10,000 mPa·s or less.

Further, the viscosity at 25° C. used in the present invention is preferably 10 mPa·s or less, and more preferably from 2 to 8 mPa·s. When the viscosity of the ink is in the above range, ejectability from the ink-jet head can well be controlled.

In addition, a measuring method of the viscosity in the present invention is as follows.

### (Measuring Method of Viscosity)

Unless otherwise indicated, the viscosity in the present invention refers to an average of the values obtained by measuring a viscosity five times every 100 seconds after the test sample has been adjusted to a predetermined temperature using a temperature-variable type rotational viscometer Physica MCR301 (trade name, manufactured by Anton Paar GmbH). It can be assumed that the viscosity obtained by the above measurement is also achieved on a recording sheet having been heated according to the recording method of the present invention described below. As the measuring conditions, shear rate of 10 (1/s) and rate of temperature rise of 5° C./5 seconds are used.

The thickening behavior of the high-temperature gelling ink is assumed as follows. The heat-sensitive material in the ink is a polymer that undergoes dissociative resolution and associative thickening at a given transition temperature. When the polymer is dissolved in a medium by hydration, the polymer dehydrates by heating. As a result, the polymer molecules interact with each other whereby the ink turns into a gel, resulting in thickening.

According to the ink of the present invention, it is possible to suppress both aggregation and color bleeding of the ink droplets in a high-speed printing because the ink of the present invention has the above properties.

Further, in the case of forming dots with such high-temperature-induced gelation ink according to the ink-jet recording method, a solvent evaporates after increase of viscosity due to gel transition. As a result, the cross-sectional shape of the dot forms a trapezoid or concave. From the viewpoint of density uniformity, a trapezoid is preferred. In the ink of the present invention, the shape of the dots to be formed is excellent whereby print qualities are also improved.

### [Heat-Sensitive Material]

The high-temperature gelling ink contains a heat-sensitive material that thickens by heating.

As one example of the heat-sensitive materials, a water-soluble cellulose ether compound is exemplified. Examples of the water-soluble cellulose ether compound used in the present invention include hydroxypropyl cellulose, hydroxypropyl methylcellulose, methylcellulose, and hydroxybutoxyl-modified methylcellulose/hydroxypropyl methylcellulose. As commercially available products of these compounds, for example, METHOCEL K100 LV, METHOCEL A-15C, or METHOCEL HB (all trade names, manufactured by The Dow Chemical Company) can be favorably used.

As another example of the heat-sensitive materials, a polymer having at least one polyethyleneoxide (PEO) block structure is exemplified. Specific examples of the polymer include polyethylene oxide, di-block polymer of polyethylene oxide-polypropylene oxide (PEO-PPO), di-block polymer of polyethylene oxide-polycaprolactone, di-block polymer of polyethylene oxide-polylactide, and tri-block copolymer of polyethylene oxide-poly propylene oxide-polyethylene oxide (PEO-PPO-PEO). A block polymer having a PEO moiety (unit) and a PPO moiety is preferred. Further, it is especially preferred to use an aqueous solution of a PEO-PPO-PEO tri-block copolymer. The copolymerization ratio is preferably in the range of from 10 to 100% by mass, more preferably from 40 to 100% by mass, and especially preferably from 60 to 90% by mass, in terms of the percentage by mass of PEO contained in the above-described polymer. The allocation of PEO allocated to both sides of the PEO block is not particularly limited. However, the allocation is preferably in the range of from 1:99 to 50:50, more preferably from 10:90 to 50:50, and still more preferably from 20:80 to 50:50.

The molecular weight of the above polymer is preferably from 1,000 to 100,000, more preferably from 8,000 to 30,000.

When described simply as a molecular weight in the present invention, the molecular weight means a number average molecular weight unless otherwise specified, and the molecular weight is a value measured by the following measuring method.

### (Measuring Method of Molecular Weight)

The molecular weight is measured using GPC (gel permeation chromatography) method, unless otherwise specified. The gel packed in the column used for GPC method is preferably a gel having an aromatic compound in the repeating unit, and examples thereof include a gel comprising a styrene-divinylbenzene copolymer. Two to six columns are preferably connected and used. The solvent used includes an ether-based solvent such as tetrahydrofuran, and an amide-based solvent such as N-methylpyrrolidinone, and an ether-based solvent such as tetrahydrofuran is preferred. The measurement is preferably performed at a solvent flow rate of 0.1 to 2 mL/min, most preferably from 0.5 to 1.5 mL/min. When the measurement is performed in this range, the measurement can be performed more efficiently without imposing a load on the apparatus. The measurement temperature is preferably from 10 to 50° C., and most preferably from 20 to 40° C.

The specific conditions for the measurement of molecular weight are shown below.

Apparatus: HLC-8220GPC (manufactured by TOSOH CORPORATION)

Detector: Differential refractometer (RI detector)

Precolumn: TSK GUARD COLUMN MP (XL), 6 mm×40 mm (manufactured by TOSOH CORPORATION)

Sample-side column: Two of the following column were directly connected (all manufactured by TOSOH CORPORATION).

TSK-GEL Multipore-HXL-M 7.8 mm×300 mm

Reference-side column: Same as the sample-side column

Thermostatic bath temperature: 40° C.

Moving phase: Tetrahydrofuran

Flow rate of sample-side moving phase: 1.0 mL/min

Flow rate of reference-side moving phase: 0.3 mL/min

Sample concentration: 0.1 mass %

Amount of sample injected: 100 μL

Data sampling time: 16 to 46 minutes after sample injection

Sampling pitch: 300 msec

Examples of the aqueous solution of the tri-block copolymer of PEO-PPO-PEO that may be preferably used include commercially available products marketed as NEWPOL PE-78 (trade name, manufactured by Sanyo Chemical Industries, Ltd.), PLURONIC P85 (trade name, manufactured by BASF Corporation), NEWPOL PE-62 (trade name, manufactured by Sanyo Chemical Industries, Ltd.), NEWPOL PE-64 (trade name, manufactured by Sanyo Chemical Industries, Ltd.), NEWPOL PE-68 (trade name, manufactured by Sanyo Chemical Industries, Ltd.), NEWPOL PE-74 (trade name, manufactured by Sanyo Chemical Industries, Ltd.), NEWPOL PE-75 (trade name, manufactured by Sanyo Chemical Industries, Ltd.), NEWPOL PE-108 (trade name, manufactured by Sanyo Chemical Industries, Ltd.), NEWPOL PE-128 (trade name, manufactured by Sanyo Chemical Industries, Ltd.), PLURONIC L62 (trade name, manufactured by BASF Corporation), PLURONIC F87 (trade name, manufactured by BASF Corporation), and polyethylene glycol-block polypropylene glycol-block polyethylene glycol (manufactured by Aldrich Corporation).

The addition amount of the heat-sensitive material is not particularly limited, as long as a thickening effect due to heating (the viscosity of the ink at 70° C. satisfies the above predetermined value) is sufficiently obtained and the tri-block copolymer achieves viscosity such that the ink is ejected from a head of the recording apparatus. However, the heat-sensitive material is added in the range of preferably from 2% by mass to 20% by mass, and more preferably from 5% by mass to 15% by mass. If the addition amount is too small, a thickening effect sometimes may not be sufficiently obtained. On the other hand, if the addition amount is too large, ink viscosity before heating becomes too high, so that ejection of the ink from a head of the recording apparatus sometimes may be affected.

Further, two or more kinds of heat-sensitive materials may be used in combination in the present invention. In this case, it is preferred to set a total content of the heat-sensitive material within the above-described range.

Further, it is preferred that the heat-sensitive material used in the present invention exists in the ink in a solution state.

### [Pigment]

As the pigment in the present invention, any known pigment can be used without any particular restriction. Above all, a pigment that is substantially insoluble or sparingly soluble in water is preferred from the standpoint of ink coloring properties. In the present invention, a water-insoluble pigment itself or a pigment itself surface-treated with a dispersant can be used as the pigment (colorant).

The pigment that may be used in the present invention is not particularly limited in its kind, and any one of the conventional organic and inorganic pigments may be used. Examples of the pigment that may be used include polycyclic pigments such as azo lake, azo pigment, phthalocyanine pigment, perylene and perynone pigments, anthraquinone pigment, quinacridone pigment, dioxadine pigment, diketopyrrolopyrrole pigment, thioindigo pigment, isoindolinone pigment and quinophthalone pigment; dye lakes such as basic dye type lake and acidic dye type lake; organic pigments such as nitro pigment, nitroso pigment, aniline black and daylight fluorescent pigment; and inorganic pigments such as titanium oxide, iron oxide type and carbon black type. Even pigments that are not described in Color Index can be used so long as they are pigments capable of being dispersed in an aqueous phase. Furthermore, those obtained by surface-treating the above-described pigments with a surfactant, a polymeric dispersant or the like, and grafted carbon can also be used. Of the above pigments, azo pigment, phthalocyanine pigment, anthraquinone pigment, quinacridone pigment and carbon black type pigment are preferably used. For black pigments, it is especially preferred to use carbon black type pigments.

Specific examples of the organic pigment used in the present invention are described below.

Examples of the organic pigment for orange or yellow include C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 128, C.I. Pigment Yellow 138, C.I. Pigment Yellow 151, C.I. Pigment Yellow 155, C.I. Pigment Yellow 180 and C.I. Pigment Yellow 185.

Examples of the organic pigment for magenta or red include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222 and C.I. Pigment Violet 19.

Examples of the organic pigment for green or cyan include C.I. Pigment Blue 15, C.I. Pigment Blue 15:2, C.I. Pigment Blue 15:3, C.I. Pigment Blue 15:4, C.I. Pigment Blue 16, C.I. Pigment Blue 60, C.I. Pigment Green 7, and siloxane-crosslinked aluminum phthalocyanine described in U.S. Pat. No. 4,311,775.

Examples of the organic pigment for black include C.I. Pigment Black 1, C.I. Pigment Black 6 and C.I. Pigment Black 7.

The average particle diameter of the pigment is preferably from 10 to 200 nm, more preferably from 10 to 150 nm, and further preferably from 10 to 100 nm. When the average particle diameter is 200 nm or less, favorable color reproducibility and dotting properties upon dotting by an ink-jet method can be achieved. When the average diameter is 10 nm or more, favorable light fastness can be achieved. The particle size distribution of the pigment is not particularly limited, and the pigment may have a wide range of particle size distribution or a monodispersible particle size distribution. Further, two or more kinds of pigment each having a monodispersible particle size distribution may be used in combination.

The average particle diameter and the particle size distribution of the pigment can be obtained by measuring the volume-average particle diameter of the pigment by a dynamic light scattering method, using a NANOTRACK particle size distribution analyzer (UPA-EX150, trade name, manufactured by Nikkiso Co., Ltd.).

The pigment may be used alone or in combination of two or more kinds. From the viewpoint of image density, the content of pigment in the ink is preferably from 1% by mass to 25% by mass, more preferably from 2% by mass to 20% by mass, still more preferably from 5% by mass to 20% by mass, and particularly preferably from 5% by mass to 15% by mass, with respect to the total amount of the ink composition.

### [Dispersant and Dispersing Medium]

Ordinarily the dispersant is a material to be added for the purpose of dispersing a pigment, and the dispersing medium (binder) is a material to be added for the purpose of improving scratch resistance, solvent resistance, water resistance, and the like. However, in the present invention, a material that is described bellow as the dispersant may be added as a dispersing medium. Accordingly, the dispersant and the dispersing medium are collectively explained below as a dispersant.

The pigment according to the present invention is preferably dispersed in an aqueous solvent by a dispersant. The dispersant may be a polymer dispersant, or a surfactant type dispersant. The polymer dispersant may be either one of a water-soluble dispersant or a water-insoluble dispersant.

The above surfactant dispersant can be added for the purpose of dispersing an organic pigment in an aqueous medium while maintaining the viscosity of the ink at a low level. The surfactant dispersant referred herein is a dispersant of which molecular weight is smaller than the polymer dispersant, and the surfactant dispersant has a mass average molecular weight of 2,000 or less. The molecular weight of the surfactant dispersant is preferably from 100 to 2,000, and more preferably from 200 to 2,000.

When the polymer dispersant is a water-soluble dispersant, examples thereof include a hydrophilic polymer compound. Examples of natural hydrophilic polymer compounds include plant polymers such as gum arabic, gum tragacanth, guar gum, gum karaya, locust bean gum, arabinogalactan, pectin and quince seed starch, algae polymers such as alginic acid, carrageenan and agar, animal polymers such as gelatin, casein, albumin and collagen, and microbial polymers such as xanthene gum and dextran.

Examples of hydrophilic polymer compounds obtained by chemically modifying natural raw materials include cellulose polymers such as methyl cellulose, ethyl cellulose, hydroxyethyl cellulose, hydroxypropyl cellulose and carboxymethyl cellulose, starch polymers such as sodium starch glycolate (sodium salt of starch glycolate), and sodium starch phosphate (sodium salt of starch phosphate[ester]), and algae polymers such as propylene glycol alginate.

Examples of synthetic hydrophilic polymer compounds include vinyl polymers such as polyvinyl alcohol, polyvinyl pyrrolidone and polyvinyl methyl ether; acrylic resins such as polyacrylamide, polyacrylic acid and alkali metal salts thereof, or water-soluble styrene acrylic resin; water-soluble styrene maleic acid resin; water-soluble vinylnaphthalene acrylic resin; water-soluble vinylnaphthalene maleic acid resins; polyvinyl pyrrolidone; polyvinyl alcohol; alkali metal salts of formalin condensates of .beta.-naphthalene sulfonic acid; polymer compounds having, at a side chain, a salt of a cationic functional group such as a quaternary ammonium group or an amino group.

Among those, a polymer compound containing a carboxyl group or a sulfonyl group is preferable from the viewpoint of dispersion stability of pigment. Polymer compounds containing a carboxyl group such as the following are particularly preferable: (meth)acrylic resins such as styrene-(meth)acrylic resins; styrene maleic acid resins; vinylnaphthalene acrylic resins; vinylnaphthalene maleic acid resins, polyvinylbenzenesulfonate resins, polystyrene-vinylbenzenesulfonate resins, and styrene-vinylbenzenesulfonate resins.

The mass average molecular weight of the polymer dispersant in the present invention is preferably from 3,000 to 200,000, more preferably from 5,000 to 100,000, further preferably from 5,000 to 80,000, and yet further preferably from 10,000 to 60,000.

The ratio of an amount of the pigment to an amount of the dispersant (pigment:dispersant) in the ink composition in terms of mass is preferably in a range of from 1:0.06 to 1:3, more preferably in a range of from 1:0.125 to 1:2, and still more preferably in a range of from 1:0.125 to 1:1.5.

### [Solvent]

The ink of the present invention is an aqueous ink. As the solvent, water, more preferably ion-exchanged water is used. Any other organic solvent may be contained for the purpose of suppressing drying, accelerating penetration, regulating viscosity, and the like.

A certain organic solvent used as an anti-drying agent can be effectively prevent nozzle clogging, which could otherwise be caused by the ink dried in the ink discharge port in the process of discharging the ink composition by ink jet method for image recording.

For the suppression of drying, a water-soluble organic solvent having a vapor pressure lower than that of water is preferably used. Examples of the water-soluble organic solvent suitable for the suppression of drying include: polyhydric alcohols such as ethylene glycol, propylene glycol, diethylene glycol, polyethylene glycol, thiodiglycol, dithiodiglycol, 2-methyl-1,3-propanediol, 1,2,6-hexanetriol, acetylene glycol derivatives, glycerin, and trimethylolpropane; heterocyclic compounds such as 2-pyrrolidone, N-methyl-2-pyrrolidone, 1,3-dimethyl-2-imidazolidinone, and N-ethylmorpholine; sulfur-containing compounds such as sulfolane, dimethylsulfoxide and 3-sulfolene; polyfunctional compounds such as diacetone alcohol and diethanolamine; and urea derivatives. In particular, polyhydric alcohols such as glycerin and diethylene glycol are preferred.

In order to accelerate the penetration, an organic solvent may be used for better penetration of the ink composition into recording media. Examples of the organic solvent suitable for penetration acceleration include alcohols such as ethanol, isopropanol, butanol, and 1,2-hexanediol, sodium lauryl sulfate, sodium oleate, and nonionic surfactants.

Besides, a water-soluble organic solvent may also be used to control viscosity. Examples of the water-soluble organic solvent that may be used to control viscosity include alcohols (e.g., methanol, ethanol and propanol), amines (e.g., ethanolamine, diethanolamine, triethanolamine, ethylenediamine, and diethylenetriamine), and other polar solvents (e.g., formamide, N,N-dimethylformamide, N,N-dimethylacetamide, dimethylsulfoxide, sulfolane, 2-pyrrolidone, acetonitrile, and acetone).

The content of the organic solvent is preferably from 0% by mass to 80% by mass, more preferably from 0% by mass to 60% by mass, and still more preferably from 0% by mass to 50% by mass with respect to the total amount of the ink.

### [Water]

The ink composition used in the invention contains water. There is no particular limitation to the content of water in the ink composition. The content of water may be from 10% by mass to 99% by mass, more preferably from 30%% by mass to 80% by mass, and still more preferably 50% by mass to 70% by mass with respect to the total amount of the ink composition.

### [Nitrogen-Containing Compound]

The ink used in the present invention may contain the compound represented by the following formula (1-1) or formula (2-1) and may contain at least two kinds of these compounds. In the ink jet recording method of the present invention, the heating temperature of the recording sheet can be suppressed to a lower temperature by this compound. In the ink used in the present invention, when a heat-sensitive material is dissolved in a medium by hydration, the heat-sensitive material dehydrates by heating. As a result, the heat-sensitive materials interact with each other. It is presumed that the ink turns into a gel by the above interaction, resulting in thickening. On the other hand, it is assumed that the compound represented by the formula (1-1) or formula (1-2) has a hydrogen-bonding property whereby dehydration of the heat-sensitive material is accelerated.

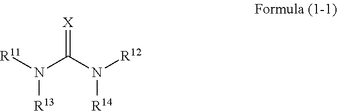

wherein R¹¹, R¹², R¹³ and R¹⁴ each independently represent a hydrogen atom or an alkyl group having 1 to 4 carbon atoms; R¹³ and R¹⁴ may be bonded to each other to form a ring; and X represents an oxygen atom or a sulfur atom; and

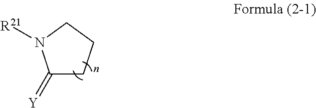

wherein R²¹ represents a hydrogen atom or an alkyl group having 1 to 4 carbon atoms; Y represents an oxygen atom or a sulfur atom; and n represents an integer of 1 to 3.

In formula (1-1), specific examples of R¹¹, R¹², R¹³ and R¹⁴ include a hydrogen atom, a methyl group, an ethyl group, a propyl group and a butyl group. Each of R¹¹, R¹², R¹³ and R¹⁴ is preferably a hydrogen atom, a methyl group, an ethyl group or a propyl group; more preferably a hydrogen atom or a methyl group.

In formula (1-1), R¹³ and R¹⁴ may be bonded to each other to form a ring. Specific examples of an alkylene group, which is formed by bonding, include an ethylene group, a propylene group and a butylene group. The alkylene group is preferably an ethylene group or a propylene group.

In formula (2-1), Y is preferably an oxygen atom.

In formula (2-1), specific examples of R²¹ include a hydrogen atom, a methyl group, an ethyl group, a propyl group and a butyl group. R²¹ is preferably a hydrogen atom, a methyl group, an ethyl group or a propyl group; more preferably a hydrogen atom or a methyl group.

In formula (2-1), n is preferably an integer of 1 to 2, and more preferably 1.

Further, the compound represented by formula (1-1) or formula (2-1) is preferably the compound represented by formula (1-2) or (2-2), respectively.

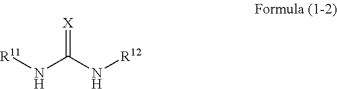

wherein R¹¹, R¹² and X have the same meanings as R¹¹, R¹² and X in formula (1-1), respectively; and the specific examples and favorable ranges thereof are also the same as those in formula (1-1).

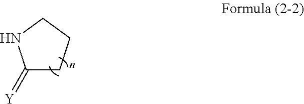

wherein Y and n have the same meanings as Y and n in formula (2-1), respectively, and the specific examples and favorable ranges thereof are also the same as those in formula (2-1).

More preferable compound represented by formula (1-2) or formula (2-2) is represented by the following formula (1-3) or formula (2-3) respectively.

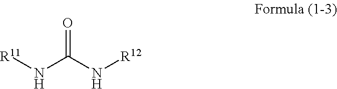

wherein R¹¹ and R¹² have the same meanings as R¹¹ and R¹² in formula (1-1), respectively, and the specific examples and favorable ranges thereof are also the same as those in formula (1-1).

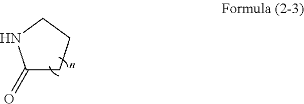

wherein n has the same meaning as n in formula (2-1), and the specific examples and favorable range thereof are also the same as those in formula (2-1).

Specific preferable examples of the compound represented by formulae (1-1) to (1-3) include urea, thiourea, N-methylurea, N,N-dimethylurea, N,N′-dimethylurea, N-methylthiourea, N,N-dimethylthiourea and N,N′-dimethylthiourea. Among them, urea, thiourea, N-methylurea, N,N-dimethylurea, N,N′-dimethylurea are more preferable; and urea is particularly preferable.

Specific preferable examples of the compound represented by formulae (2-1) to (2-3) include 2-pyrrolidone and N-methylpyrrolidone. Among them, 2-pyrrolidone is more preferable.

As the addition amount of the nitrogen-containing compound, it is preferred to add the nitrogen-containing compound to the ink in an amount of more than 7% by mass, more preferably more than 7% by mass and 40% by mass or less, and still more preferably more than 7% by mass and 25% by mass or less. If the addition amount is too small, the thickening effect due to addition of the nitrogen-containing compound may not be obtained sufficiently. On the other hand, if the addition amount is too large, the ink viscosity at room temperature increases, so that ejection may become difficult.

In addition, the addition amount of the nitrogen-containing compound is adjusted so that the thickening behavior of the ink becomes as described above. Further, the addition amount of the nitrogen-containing compound is preferably in the range of from 0.23 to 40% by mass in terms of the ratio by mass of the nitrogen-containing compound with respect to the heat-sensitive material.

### [Other Additives]

The ink composition of the invention may further contain other components (additives) in accordance with necessity. Examples of such other components include known additives such as an anti-fading, an emulsion stabilizer, a permeation accelerator, an ultraviolet absorber, a preservative, an antifungal agent, a pH regulator, a surface tension regulator, a defoaming agent, a viscosity adjusting agent, a dispersant, a dispersion stabilizer, an anti-rust agent or a chelating agent. Those various additives may directly be added after preparation of the ink composition, or may be added at the time of preparation of the ink composition.

### [Ultraviolet Absorber]

The ultraviolet absorber is used for the purpose of improving preservability of an image. The ultraviolet absorber can use benzotriazole compounds described in, for example, JP-A Nos. 58-185677, 61-190537, 2-782, 5-197075 and 9-34057; benzophenone compounds described in, for example, JP-A Nos. 46-2784 and 5-194483, and U.S. Pat. No. 3,214,463; cinnamic acid compounds described in, for example, JP-B Nos. 48-30492 and 56-21141, and JP-A No. 10-88106; triazine compounds described in, for example, JP-A Nos. 4-298503, 8-53427, 8-239368 and 10-182621, and JP-A No. 8-501291; compounds described in Research Disclosure No. 24239; and compounds that absorb ultraviolet light and emit fluorescence, i.e., fluorescent brighteners, represented by stilbene compounds or benzoxazole compounds.

### [Color Fading Inhibitor]

The color fading inhibitor is used for the purpose of improving storability of an image. Examples of the color fading inhibitor that can be used include various organic color fading inhibitors and metal complex color fading inhibitors. Examples of the organic color fading inhibitor include hydroquinones, alkoxyphenols, dialkoxyphenols, phenols, anilines, amines, indanes, chromenes, alkoxyanilines and heterocycles. Examples of the metal complex color fading inhibitor include a nickel complex and a zinc complex. More specifically, compounds described in the patents cited in Research Disclosure No. 17643, chapter VII, items Ito J; Research Disclosure No. 15162: Research Disclosure No. 18716, page 650, the left-hand column; Research Disclosure No. 36544, page 527; Research Disclosure No. 307105, page 872; and Research Disclosure No. 15162, and compounds included in the formulae of the representative compounds and the exemplified compounds described on pages 127 to 137 of JP-A No. 62-215272 can be used.

### [Mildew-Proofing Agent]

Examples of the mildew-proofing agent include sodium dehydroacetate, sodium benzoate, sodium pyridinethion-1-oxide, p-hydroxybenzoic acid ethyl ester, 1,2-benzisothiazolin-3-one and its salt. Those are preferably used in the water-based ink composition in an amount of from 0.02 to 1.00% by mass.

### [pH Regulator]

As the pH regulator, a neutralizer (organic base and inorganic alkali) may be used. The pH regulator may be added in an amount such that the water-based ink composition has pH of preferably from 6 to 10, and more preferably from 7 to 10, for the purpose of improving storage stability of the water-based ink composition.

### [Surface Tension Regulator]

Examples of the surface tension regulator include nonionic surfactants, cationic surfactants, anionic surfactants, and betaine type surfactants.

For smooth ejection in the ink-jet recording method, the amount of addition of the surface tension regulator is preferably such that the surface tension of the ink composition can be adjusted in the range of from 20 mN/m to 60 mN/m, more preferably from 20 mN/m to 45 mN/m, further preferably from 25 mN/m to 40 mN/m.

The surface tension of the ink composition may be measured by a plate method using AUTOMATIC SURFACE TENSIOMETER CBVP-Z (trade name, manufactured by Kyowa Interface Science Co., LTD.) under the temperature condition of 25° C.

### [Surfactant]

Preferable examples of the surfactant include hydrocarbon anionic surfactants such as fatty acid salts, alkyl sulfate ester salts, alkyl benzenesulfonates, alkyl naphthalenesulfonates, dialkyl sulfosuccinates, alkyl phosphate ester salts, naphthalenesulfonic acid-formalin condensates, and polyoxyethylene alkyl sulfate ester salts; and nonionic surfactants such as polyoxyethylene alkyl ethers, polyoxyethylene alkyl allyl ethers, polyoxyethylene fatty acid esters, sorbitan fatty acid esters, polyoxyethylene sorbitan fatty acid esters, polyoxyethylene alkylamines, glycerin fatty acid esters, and oxyethylene-oxypropylene block copolymers. Acetylene polyoxyethylene oxide surfactants SURFYNOLs (trade name, manufactured by Air Products & Chemicals, Inc.) and OLFINE E1010 (trade name, manufactured by Nissin Chemical Industry Co., Ltd., surfactant) are also preferably used. Amine oxide type amphoteric surfactants such as N,N-dimethyl-N-alkylamine oxide are also preferrable.

The surfactants listed in pages 37 to 38 of JP-A No. 59-157636 and Research Disclosure No. 308119 (1989) may also be used.

Fluorocarbon (alkyl fluoride type) surfactants or silicone surfactants as described in JP-A Nos. 2003-322926, 2004-325707 and 2004-309806 may be used to improve the rubbing resistance.

The surface tension regulator may also be used as a defoaming agent, and fluorine compounds, silicone compounds, and chelating agents such as EDTA may also be used.

In the ink of the present invention, a thickener, a conductivity improver, a kogation inhibitor (“kogation” means solid deposits baked onto the surface of a heater), a desiccant, a water-resistant ruggedization agent, a light stabilizer, a buffering agent, an anti-curling agent, or the like further may be added. Examples of the buffering agent include sodium borate, sodium hydrogenphosphate, sodium dihydrogenphosphate, and a mixture thereof. However, the buffering agent is not limited thereto.

Next, the ink set of the present invention will be described.

### [Ink Set]

The ink set of the present invention contains at least a yellow hue ink, a magenta hue ink, a cyan hue ink, and a black hue ink. Further, these inks are high-temperature gelling inks described above. Further, it is preferred that these inks satisfy the following relation of viscosity at 70° C.: black ink<cyan ink<magenta ink<yellow ink. These ink set may further contain inks having other hues as may be necessary. In this case, the order of viscosities of inks having other hues at 70° C. is the same as in the explanation of the ink-jet recording method.

In the present invention, it is preferred that the viscosity of each in the ink set is 10 mPa·s or less at 25° C. and 100 mPa·s or more at 70° C.

The ink set produced as described above can be favorably used for the above-described ink-jet recording method of the present invention.

The present invention is contemplated for providing an ink jet recording method capable of preventing dot bleeding especially at the overlap portion between the first-order color and the second-order color in formation of the multi-order color image that uses a high-temperature gelling ink, and capable of achieving high-quality printing with a high density. In addition, the present invention is contemplated for providing an ink set capable of achieving high-quality printing with reduced bleeding and a high density using the above-described ink-jet recording method.

According to the ink jet recording method of the present invention, by adjusting a high-temperature gelling ability of the ink having each color hue in accordance with the ejecting order of the multi-order color image printing, it is possible to prevent dot bleeding at the overlap portion between the first-order color and the second-order color and further to form a more favorable quality image with a high density at a high speed.

The ink set of the present invention can be used for the formation of a multi-order color image in accordance with the above-described ink jet recording method whereby dot bleeding can be prevented and high-quality image with a high density can be formed at a high speed.

The present invention will be described in more detail based on the following examples, but the invention is not intended to be limited thereto. In the following examples, the terms “part(s)” and “%” are values by mass, unless otherwise specified.

In addition, the weight average molecular weight was measured by gel permeation chromatography (GPC). HLC-8220 GPC (trade name, manufactured by TOSOH CORPORATION) was used for the GPC, and TSK GEL Super HZM-H, TSK GEL Super HZ4000, and TSK GEL Super HZ2000 (trade names, all manufactured by TOSOH CORPORATION) were used as the columns and were connected in a series of three. THF (tetrahydrofuran) was used as the eluent solution. For the conditions, the sample concentration was 0.35% by mass, the flow rate was 0.35 mL/min, the amount of sample injection was 10 the measurement temperature was 40° C., and an RI detector was used. A calibration curve was prepared from 8 samples of the “standard sample TSK standard, polystyrene”: “F-40”, “F-20”, “F-4”, “F-1”, “A-5000”, “A-2500”, “A-1000” and “n-propylbenzene” (trade names, manufactured by TOSOH CORPORATION).

### EXAMPLES

### Example 1

### ——Synthesis of Water-Insoluble Polymer Dispersant P-1——

88 g of methyl ethyl ketone was added to a 1000-ml three-necked flask equipped with a stirrer and a condenser tube, and was heated to 72° C. under a nitrogen atmosphere. To this, a solution of 0.85 g of dimethyl 2,2′-azobisisobutyrate, 60 g of benzyl methacrylate, 10 g of methacrylic acid and 30 g of methyl methacrylate dissolved in 50 g of methyl ethyl ketone was added dropwise over a period of 3 hours. After the addition was completed, the mixture was reacted for additional one hour, and then a solution of 0.42 g of dimethyl 2,2′-azobisisobutyrate dissolved in 2 g of methyl ethyl ketone was added. The temperature was elevated to 78° C., and the mixture was heated for 4 hours. The obtained reaction solution was precipitated two times in large excess of hexane, and the precipitated resin was dried to obtain 96 g of a water-insoluble polymer dispersant P-1.

The composition of the obtained resin was confirmed by ¹H-NMR, and the weight average molecular weight (Mw) determined by GPC was 44,600. The acid value was determined by the method described in JIS Standards (JIS K0070: 1992), and the value was 65.2 mgKOH/g.

### ——Preparation of Dispersion K of Resin-Coated Carbon Black Particles (Pigment Dispersion)——

Carbon black and other components were mixed according to the following composition and dispersed with a beads mill using 0.1 mm φ zirconia beads for 3 to 6 hours. From the resulting dispersion, the methyl ethyl ketone was removed at 55° C. under reduced pressure, and further, a part of the water was removed, whereby a dispersion of resin-coated carbon black particles having a carbon black concentration of 10.0% by mass was prepared.

### (Composition of Dispersion K of Resin-Coated Carbon Black Particles)

| | |
|---|---|
| Carbon black (trade name: NIPEX 180-IQ, manufactured | 10.0 parts |
| by Degussa; specific surface area by BET method: 260 m²/g) | |
| Water insoluble Polymer dispersant P-1 | 4.5 parts |
| Methyl ethyl ketone (organic solvent) | 30.5 parts |
| 1 mol/L NaOH aqueous solution (neutralizing agent) | 6.3 parts |
| Polyoxyethylene Lauryl Ether (nonionic surfactant, Emalgen | 0.1 part |
| 109 P (trade name), manufactured by KAO Corporation, | |
| HLB: 13.6) | |
| Ion-exchanged water | 98.6 parts |

### (Particle Size Measurement of Resin-Coated Carbon Black Particles)

The resulting dispersion of resin-coated carbon black particles (pigment dispersion) was measured for its volume-average particle size by a dynamic light scattering method using a particle size distribution measuring instrument NANOTRAC UPA-EX 150 (trade name, manufactured by NIKKISO Co., Ltd.). In this measurement, 10 mL of ion-exchanged water was added to 30 μL, of the resin-coated carbon black particle dispersion to prepare a measurement sample, and the thus prepared sample was then measured at a controlled temperature of 25° C. The obtained particle size was 98 nm.

### ——Preparation of Dispersion C of Cyan Coloring Particles——

10 parts of pigment blue 15:3 (trade name: PHTHALOCYANINE BLUE A220, manufactured by Dainichiseika Color & Chemicals Mfg. Co., Ltd; cyan pigment), 5 parts of the polymer dispersant P-1, 42 parts of methyl ethyl ketone, 5.5 parts of an aqueous 1N NaOH solution, and 87.2 parts of ion exchange water were mixed, and the mixture was dispersed for 2 to 6 hours by means of a bead mill using zirconia beads having a diameter of 0.1 mm.

From the obtained dispersion, methyl ethyl ketone was removed at 55° C. under reduced pressure, and further water was partially removed. Then, the resultant was subjected to centrifugal treatment using a 50 mL centrifuging tube by means of a HIGH-SPEED CENTRIFUGAL COOLER 7550 (trade name, manufactured by Kubota Corporation) at 8000 rpm for 30 minutes, thereby collecting the supernatant excluding the precipitate. Thereafter, the pigment concentration was determined from the absorbance spectrum, thereby obtaining a dispersion C of cyan coloring particles that is a dispersion of resin-coated pigment particles (pigment coated with a polymer dispersant) and has a pigment concentration of 10.2% by mass.

### ——Preparation of Dispersion Y of Yellow Coloring Particles and Dispersion M of Magenta Coloring Particles——

Dispersion Y of yellow coloring particles and dispersion M of magenta coloring particles were prepared in the same manner as the above-described dispersion C of cyan coloring particles except that pigment blue 15:3 in the dispersion C of cyan coloring particles was changed to pigment yellow 74 (IRGALITE YELLOW GS, manufactured by Ciba Japan) and pigment red 122 (CROMOPHTAL JET MAGENTA, manufactured by Ciba Specialty Chemicals Inc.), respectively. The pigment densities of the dispersion Y of yellow coloring particles and the dispersion M of magenta coloring particles were 10.3% by mass and 10.1% by mass, respectively.

### (Measurement of Particle Diameters)

The particle diameters of the thus-obtained dispersion Y of yellow coloring particles, dispersion M of magenta coloring particles and dispersion C of cyan coloring particles were measured in the same manner as the dispersion K of carbon black particles. Results of measurement were as follows. Y: 115 nm, M: 105 nm, C: 97 nm

### ——Preparation of Black Inks K1 and K2——

Then, the resulting dispersion of resin-coated carbon black particles was used to prepare an aqueous ink with the following composition. A plastic disposable syringe was filled with this aqueous ink, and then filtrated using a PVDF 5 μm filter (Millex-SV (trade name), manufactured by MILLIpore Corporate, diameter: 25 mm). Thus, a black ink (ink-jet ink composition) K1 which gels at high temperature was obtained. The pH of the aqueous ink at 25° C. was 8.7.

### <Composition of Black Ink K1>

| | |
|---|---|
| Dispersion K of resin-coated carbon black | 40.0 parts |
| NEWPOL PE-78 (PEO-PPO-PEO triblock polymer, | 9.0 parts |
| manufactured by Sanyo Chemical Industries, Ltd., | |
| trade name) (Mn: 8700, containing PEO by 80% by mass) | |
| Urea (manufactured by Wako Pure Chemical Industries, Ltd.) | 15.0 parts |
| Olfine E1010 (surfactant, manufactured by Nissin | 1.0 part |
| Chemical Industry Co., Ltd., trade name) | |
| Ion-exchanged water | 35.0 parts |

Black ink K2 was prepared in the same manner as Black ink K1 except that the ink was changed to the following composition. The pH of the aqueous ink at 25° C. was 8.8.

### <Composition of Black ink K2>

| | |
|---|---|
| Dispersion K of resin-coated carbon black | 40.0 parts |
| NEWPOL PE-108 (PEO-PPO-PEO triblock polymer, | 7.0 parts |
| manufactured by Sanyo Chemical Industries, Ltd., | |
| trade name) (Mn: 16250, containing PEO by 80% by mass) | |
| Urea (manufactured by Wako Pure Chemical Industries, Ltd.) | 15.0 parts |
| Olfine E1010 (surfactant, manufactured by Nissin Chemical | 1.0 part |
| Industry Co., Ltd., trade name) | |
| Ion-exchanged water | 37.0 parts |

——Preparation of Color Inks Y1, Y2, M1, M2, C1 and C2——Yellow inks Y1 and Y2, magenta inks M1 and M2 and cyan inks C1 and C2 were prepared in the same manner as the Black ink K1 except that the composition of each inks was changed to the ink composition (mass part) in Table 1. The viscosity at 25° C. and 70° C., and pH at 25° C. of each of the obtained aqueous ink-jet inks were measured. The results are shown in Table 1. The value of viscosity was defined as an average of the values obtained by measuring a viscosity five times every 100 seconds after the test sample has been adjusted to a predetermined temperature shown in Table 1 using a temperature-valuable type rotational viscometer Physica MCR301 (trade name, manufactured by Anton Paar GmbH). As the measuring conditions, shear rate of 10 (1/s) and rate of temperature rise of 5° C./5 seconds were used. The composition, viscosity and pH of black inks K1 and K2 were also shown in Table 1.

TABLE 1

| Ink | Y1 | Y2 | M1 | M2 | C1 | C2 | K1 | K2 |
|---|---|---|---|---|---|---|---|---|
| Dispersion Y of yellow coloring | 38.8 | 38.8 | — | — | — | — | — | — |
| particles | | | | | | | | |
| Dispersion M of magenta coloring | — | — | 39.6 | 39.6 | — | — | — | — |
| particles | | | | | | | | |
| Dispersion C of cyan coloring | — | — | — | — | 39.2 | 39.2 | — | — |
| particles | | | | | | | | |
| Dispersion K of carbon black | — | — | — | — | — | — | 40.0 | 40.0 |
| particles | | | | | | | | |
| NEWPOL PE-78 | 10.0 | — | 10.0 | — | 9.0 | — | 7.0 | — |
| NEWPOL PE-108 | — | — | — | — | — | 7.0 | — | 5.0 |
| NEWPOL PE-128(*) | — | 5.0 | — | 4.0 | — | — | — | — |
| Urea | 15.0 | 15.0 | 15.0 | 15.0 | 15.0 | 15.0 | 15.0 | 15.0 |
| OLFINE E1010 | 1.0 | 1.0 | 1.0 | 1.0 | 1.0 | 1.0 | 1.0 | 1.0 |
| Ion-exchanged water | 35.2 | 40.2 | 34.4 | 40.4 | 35.8 | 37.8 | 37.0 | 39.0 |
| Viscosity (25° C.) mPa · s | 5.8 | 6.2 | 5.9 | 6.0 | 5.6 | 5.8 | 5.1 | 5.6 |
| Viscosity (70° C.) mPa · s | 260 | 1204 | 251 | 995 | 230 | 940 | 203 | 790 |
| pH (25° C.) | 8.5 | 8.4 | 8.6 | 8.4 | 8.7 | 8.6 | 8.7 | 8.8 |

(*)NEWPOL PE-128 (trade name, manufactured by Sanyo Chemical Industries Ltd., PEO-PPO-PEO triblock polymer, Mn: 20000, mass ratio of PEO relative to a total amount of the polymer: 80%)

### Example I

### —Recording of Image—

An apparatus was prepared in which four piezoelectric heads 1 to 4 (each 384 nozzles) were disposed side by side, and a heater capable of heating a printing paper was set. In the apparatus, the heads were arranged so that ejecting was carried out in order of from head 1 to head 4. Each head was filled with black, cyan, magenta or yellow inks according to Table 2 to prepare an ink set. Further, a recording voltage was modulated so that the ink droplet size fell in the range of from 7 to 8 pl. A normal paper NPi-55 (trade name, manufactured by Nippon Paper Industries Co., Ltd., basis weight: 55 g/m²) was set on a heater, and then heated so that the temperature on the plane of paper became 70° C. After that, by ejecting inks of desired color from piezo-type recording heads 1 to 4, 1 cm×1 cm-size five-step images having halftone dot percentage of 100%, 80%, 60%, 40%, and 20% (which were constituted of the second-order color and the third-order color) were printed in a single pass mode. The temperature on the plane of paper was measured using a radiation thermometer (trade name: IR-66B, manufactured by MK Scientific, Inc.). In addition, the printing condition is as follows.

### <Printing Condition>

Printing speed: 100 m/min

### Resolution: 600 dpi

Interval (Distance) between head and paper: 0.5 mm

TABLE 2

| | | | Piezo | Piezo | Piezo | Piezo |
|---|---|---|---|---|---|---|
| No. | | Color | head 1 | head 2 | head 3 | head 4 |
| 1 | Example 1 | Red | — | — | M1 | Y2 |
| 2 | Example 2 | Red | — | — | M2 | Y2 |
| 3 | Example 3 | Green | — | C1 | — | Y2 |
| 4 | Example 4 | Green | — | C2 | — | Y2 |
| 5 | Example 5 | Blue | — | C1 | M2 | — |
| 6 | Example 6 | Blue | — | C2 | M2 | — |
| 7 | Example 7 | Gray | K1 | C2 | M2 | Y2 |
| 8 | Comparative | Red | — | — | M2 | Y1 |
| | example 1 | | | | | |
| 9 | Comparative | Green | — | C2 | — | Y1 |
| | example 2 | | | | | |
| 10 | Comparative | Blue | — | C2 | M1 | — |
| | example 3 | | | | | |
| 11 | Comparative | Gray | K2 | C1 | M1 | Y1 |
| | example 4 | | | | | |

Evaluation of the printed matters was conducted as follows.

### (Evaluation of Bleeding)

A dot portion of the printed halftone dot image having a halftone dot percentage of 40% was observed at a magnification of 20 times with a microscope. Dot bleeding of the second-order color (composite gray with respect to Example 7 and Comparative Example 4) was evaluated on the basis of the following criterion. The obtained results are shown in 3.

### (Criterion of Bleeding Evaluation)

A: Dots of different colors from each other are properly separated at the overlap portion between these dots.
B: Bleeding is seen in a part of dot edge at the overlap portion between dots having different colors from each other.
C: Bleeding is seen in the dot of the later-printed color at the overlap portion between dots having different colors from each other.

TABLE 3

| | Bleeding | Remarks |
|---|---|---|
| Example 1 | A | Dot bleeding is not observed. |
| Example 2 | A | Dot bleeding is not observed. |
| Example 3 | A | Dot bleeding is not observed. |
| Example 4 | A | Dot bleeding is not observed. |
| Example 5 | A | Dot bleeding is not observed. |
| Example 6 | A | Dot bleeding is not observed. |
| Example 7 | A | Dot bleeding is not observed. |
| Comparative example | C | Dot bleeding of yellow is observed. |
| 1 | | |
| Comparative example | C | Dot bleeding of yellow is observed. |
| 2 | | |
| Comparative example | C | Dot bleeding of magenta is observed. |
| 3 | | |
| Comparative example | C | Dot bleeding of yellow and |
| 4 | | magenta is observed. |

As is apparent from Table 3, bleeding was observed at the dot of later-printed color in Comparative Examples 1 to 4. In contrast, good-quality printed matters were obtained without any dot bleeding in Examples 1 to 7. Therefore, it is understood that in the case of using the ink set in which high-temperature gelling inks having different colors from each other are used in combination, images improved in terms of bleeding at the color-overlapped portion can be obtained by setting the ejecting order so as to depend on the viscosity of the ink at 70° C.

### Example II

### ——Full Color Image Recording——

Full color image recording was carried out by using ink sets 7 and 11 prepared in Example I in accordance with both the ejecting order and the recording condition used in Example I. Then, evaluation of comprehensive image quality was conducted. In addition, images were printed after selecting three kinds of each of portrait and scenic image. A sensory evaluation was conducted laying the images having been obtained by using the ink sets 7 and 11 side by side. As a result, in each of the images, recording that was carried out by using the ink set 7 (Examples of the present invention) was able to achieve better-picture quality than that using the ink set 11 (Comparative Examples). Specifically, the images obtained by Examples of the present invention were better images having higher sharpness and less feeling of roughness than the images obtained by Comparative Examples. Moreover, for the images obtained by Examples of the present invention, bleeding was also prevented in multi-order colors such as a second-order color or a third-order color.

Having described our invention as related to the present embodiments, it is our intention that the present invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2010-067975 filed in Japan on Mar. 24, 2010, which is entirely herein incorporated by reference.

What we claim is:

1. An ink-jet recording method, comprising the steps of:
ejecting droplets of inks from an orifice of a recording head onto a recording sheet in response to recording signals; and
heating the recording sheet to 70° C. or higher before the droplets of the ink land on the recording sheet or at the time of landing thereof, thereby to form a multi-order color image on the recording sheet,
wherein the inks are two or more kinds of inks that thicken by heating and have different color hues from each other, and
wherein the droplets of the inks are ejected in sequence from the ink having the lowest viscosity at 70° C. among the inks.

2. The ink jet recording method according to claim 1, wherein the ink comprises a pigment, water, and a heat-sensitive material.

3. The ink jet recording method according to claim 2, wherein the above-described heat-sensitive material is a block polymer containing an ethylene oxide moiety and a propylene oxide moiety.

4. The ink jet recording method according to claim 1, wherein each of the two or more kinds of inks has a viscosity of 10 mPa·s or less at 25° C. and 100 mPa·s or more at 70° C.

5. The ink jet recording method according to claim 1, wherein the recording sheet is printed in a single pass mode.

6. The ink-jet recording method according to claim 1, wherein the two or more kinds of inks having different color hues comprise a yellow ink, a magenta ink, a cyan ink, and a black ink.

7. The ink jet recording method according to claim 6, wherein the inks satisfy the following relation in terms of viscosity at 70° C. thereof:
the black ink<the cyan ink<the magenta ink<the yellow ink.

8. An ink set, comprising inks which thicken by heating,
wherein the inks comprise color hues of black, cyan, magenta, and yellow, and
wherein the inks satisfy the following relation in terms of viscosity at 70° C. thereof:
the black ink<the cyan ink<the magenta ink<the yellow ink.

9. The ink set according to claim 8, wherein each of the inks has a viscosity of 10 mPa·s or less at 25° C. and 100 mPa·s or more at 70° C.
